(19) United States
(12) Patent Application Publication
(10) Pub. No.: US 2011/0022943 A1
(43) Pub. Date: Jan. 27, 2011

(54) DOCUMENT OBJECT MODEL (DOM) APPLICATION FRAMEWORK

(75) Inventors: Akram Bou-Ghannam, Boca Raton, FL (US); Gregory T. Brown, Atlanta, GA (US); Calvin Lawrence, Atlanta, GA (US); John W. Miller, Atlanta, GA (US)

Correspondence Address: LEE LAW, PLLC;IBM CUSTOMER NUMBER, P.O. BOX 189, PITTSBORO, NC, 27312, US

(73) Assignee: INTERNATIONAL BUSINESS MACHINES CORPORATION, Armonk, NY (US)

(21) Appl. No.: 12/507,937

(22) Filed: Jul. 23, 2009

(51) Int. Cl. G06F 17/00; G06F 3/048

(52) U.S. Cl. 715/234; 715/810

(57) ABSTRACT

A document object model (DOM) representation of an element of web content received from a web content source is identified via a processor. The DOM representation of the element of web content is extracted from the web content source. The extracted DOM representation is stored as a first reusable DOM component within a memory associated with the processor.

### BACKGROUND

The present invention relates to web-oriented application development. More particularly, the present invention relates to a document object model (DOM) application framework.

Web application development is primarily based upon use of available content rendering and scripting languages, such as extensible markup language (XML) and JavaScript®, respectively. Static objects may be designed for web applications using XML, while behavioral aspects of an application may be developed using JavaScript®. Developers generate web content files using one of the available rendering or scripting languages.

When a web page is requested by a computing device, the associated file that includes the content rendering and/or scripting languages is downloaded to the computing device along with the associated web content elements. Content objects are created for rendering within a browser of the computing device by instantiating a document object model (DOM) that represents the web content elements associated with the requested web page. The DOM is a hierarchical model of the rendered web content elements. If the user interacts with a scripted portion of the content, the scripting language is interpretively processed and executed by the browser.

### SUMMARY

A method includes identifying, via a processor, a document object model (DOM) representation of an element of web content received from a web content source; extracting the DOM representation of the element of web content from the web content source; and storing the extracted DOM representation as a first reusable DOM component within a memory associated with the processor.

A system includes a memory; and a processor programmed to: identify a document object model (DOM) representation of an element of web content received from a web content source; extract the DOM representation of the element of web content from the web content source; and store the extracted DOM representation as a first reusable DOM component within the memory.

A computer program product includes a computer readable storage medium including a computer readable program, wherein the computer readable program when executed on a computer causes the computer to: identify a document object model (DOM) representation of an element of web content received from a web content source; extract the DOM representation of the element of web content from the web content source; and store the extracted DOM representation as a first reusable DOM component within a memory.

### BRIEF DESCRIPTION OF THE SEVERAL VIEWS OF THE DRAWINGS

FIG. 1 is a block diagram of an example of an implementation of a system for use in association with a document object model (DOM) application framework according to an embodiment of the present subject matter;

FIG. 2 is a block diagram of an example of an implementation of a DOM application development device that provides the DOM application framework according to an embodiment of the present subject matter;

FIG. 3 is a flow chart of an example of an implementation of a process for providing a DOM application framework according to an embodiment of the present subject matter;

FIG. 4 is a flow chart of an example of an implementation of a process for DOM component harvesting from a server according to an embodiment of the present subject matter;

FIG. 5A is a flow chart of an example of an implementation of initial processing within a process that provides a DOM application framework and that provides a user of a device, such as the DOM application development device, with functionality to build and execute DOM applications according to an embodiment of the present subject matter; and

FIG. 5B is a flow chart of an example of an implementation of additional processing within the process illustrated in FIG. 5A for executing the DOM application that has been built according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides a document object model (DOM) application framework. The DOM application development framework provides situational application framework with run-time introspection that operates on elements of content directly at the document object model (DOM) level. The DOM is language and platform independent. DOM components are created and are stored within a memory as reusable DOM components. The reusable DOM components may be rendered (e.g., instantiated) in the memory of a DOM application system as DOM objects, rather than displaying the elements as conventional web content, along with any underlying executable code. The DOM objects may be selected and combined to form DOM applications. Input and output requirements for instantiated DOM objects may be integrated at the DOM level. Elements of existing web content that is rendered via a DOM hierarchy may also be captured for reuse at the DOM level. Existing DOM components with associated executable aspects may also be captured for reuse provided the associated underlying executable code may be retrieved from its web content source (e.g., from a web server or a markup language (ML) document). Whether the objects are static for display, dynamic with behavioral attributes, interactive elements (e.g., forms) with input and/or output requirements, or other types of content, the DOM application framework provides a foundational underpinning for the creation and capture of reusable DOM objects that may be integrated at run time to form DOM applications.

Based upon the present subject matter, DOM components may be constructed as stand-alone DOM objects that may be instantiated as DOM objects and integrated to form DOM applications. DOM objects may also be captured from a web source for use in a DOM application. Stand-alone DOM objects may be encapsulated to provide stand-alone functionality. DOM applications may be constructed entirely of encapsulated DOM objects that provide compartmentalized functionality.

Additionally, DOM objects may have inputs and outputs with associated executable code. Integration of the associated inputs and outputs for a DOM object may be performed at the DOM hierarchy level based upon the present subject matter.

Leaf nodes within a DOM hierarchy may be captured to create DOM components based upon existing web content. If a DOM leaf node has associated accessible executable code, that executable code may be captured and may form a part of the captured DOM component. Both created and captured DOM components may be reused to provide an increasing repository of reusable DOM components that may be instantiated to form DOM applications. Because DOM components are language and platform independent, the DOM components may be instantiated into executable DOM objects and integrated to form DOM applications via any suitable platform.

The DOM application framework may form a portion of a situational application editor (SAE). The situational application editor allows a user to capture and integrate remote DOM objects with instantiated local DOM objects. This capture and integration of remote and local DOM objects facilitates formation of DOM applications on the fly for use during a single DOM application instantiation. A user of the present subject matter may string functionality from multiple web sites (e.g., business domains) into higher-level components with higher level functionality. A created DOM application may also be stored and reused as an application-level process.

As such, for purposes of the present subject matter, anything web content that may be used to generate a DOM representation for interaction with a browser may be considered a candidate for becoming a reusable DOM component. Further, “executable” DOM objects may be annotated with metadata to add a new interface that defines inputs and outputs. Creation of new personalized DOM components may be created and used in the end-user workspace. DOM components may be instantiated into DOM objects and assembled to create workflows defined in the end-user workspace. Implementation of cross-cutting functions, such as aspect oriented programming (AOP), may be implemented to facilitate security, transaction, and persistence, and other additional features may be use to augment user-defined workflows.

Additionally, real-time processing may be performed in the form of introspection to look into and identify functional aspects of executable DOM objects during operations such as capture, storage, and/or instantiation of DOM objects. Using introspection, input, output, and trigger parameters for instantiated executable DOM objects may be defined during run time. Identified parameters may be stored as metadata in association with instantiable DOM components.

One example of a DOM application and its use is provided by positing that a user wishes to create an impromptu run-time application to determine an amount of gasoline that will be used by a particular vehicle during a given trip. If created reusable DOM components are stored locally within a memory or are available via a web server for capture and reuse, and these reusable DOM components may be instantiated to provide the mileage per gallon for the vehicle and the distance between the starting and ending locations, then these DOM components may be instantiated as DOM objects and integrated at the DOM level to provide the user's requested information.

Alternatively, if the user finds a web site that provides a user interface to an instantiated DOM object that provides the mileage per gallon for the vehicle and finds a separate web site that provides the distance between the starting and ending locations, these DOM objects may be captured and rendered locally to form a situational application for the user's purposes. The DOM objects may be integrated from the different web sites locally and the user may determine the amount of gasoline that may be used during the trip. If the user then wishes to determine the cost of gasoline for the trip, the user may find another site that provides accessible DOM objects with gasoline costs for various locations along the trip and the user may capture and integrate these DOM objects on the fly to determine the cost of gasoline for the trip. The user may further wish to determine the cost of lodging during the trip and may capture and integrate DOM objects on the fly to determine this information based upon the previously-integrated DOM objects. Many other possibilities exist for use of the present subject matter and all are considered within the scope of the present subject matter.

The present subject matter also provides run-time DOM application creation and execution capabilities within the DOM application framework. For example, an DOM component that provides functionality may be retrieved from a web content source, stored in a local memory as a reusable DOM component, instantiated as a useable DOM object, and executed at an application level—all during run time for an DOM application. As such, the term “run time” and related terms may be applied broadly to include, among other things, operations performed during one or more execution phases for a DOM application.

The DOM application framework described herein may be performed in real time to allow prompt capture, creation, and reuse of DOM objects for application generation. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

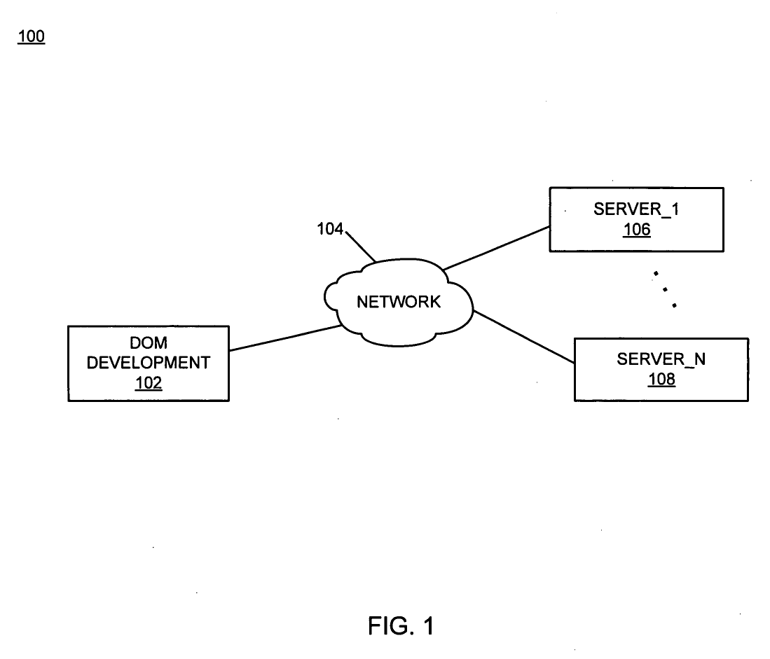

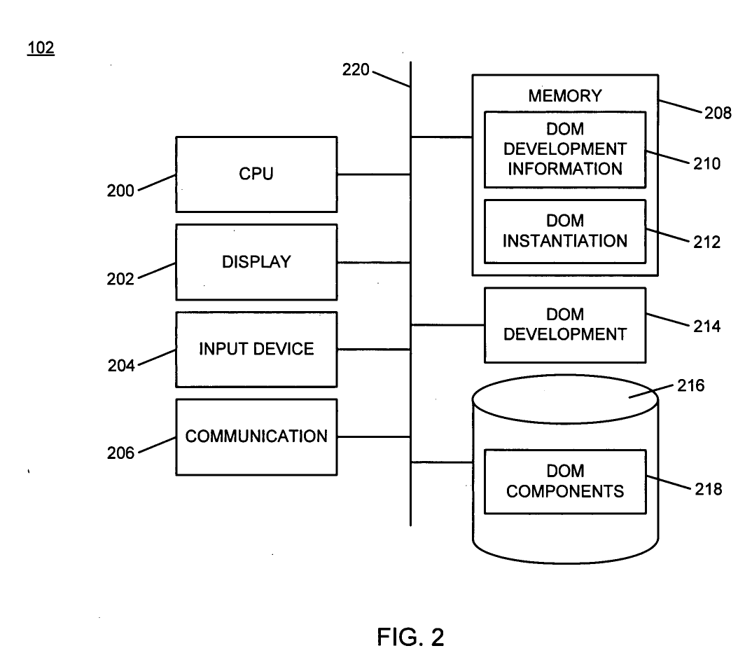

FIG. 1 is a block diagram of an example of an implementation of a system 100 for use in association with a document object model (DOM) application framework. Within the system 100, a DOM application development device 102 is shown interconnected via a network 104 to a server_1 106 through a server_N 108. As will be described in more detail below in association with FIG. 2 through FIG. 5B, the DOM application development device 102 provides the DOM application framework useable to create, capture, store, instantiate, and reuse DOM components. The DOM application development device 102 also provides integration and application capabilities for users of the DOM application development device 102 to create DOM applications based upon instantiated DOM objects.

It should be noted that the DOM application development device 102 may be a portable computing device, either by a user's ability to move the DOM application development device 102 to different locations or by the DOM application development device 102's association with a portable platform, such as a plane, train, automobile, or other moving vehicle. It should also be noted that the DOM application development device 102 may be any computing device capable of processing information as described above and in more detail below. For example, the DOM application development device 102 may include devices such as a personal computer (e.g., desktop, laptop, palm, etc.) or a handheld device (e.g., cellular telephone, personal digital assistant (PDA), email device, music recording or playback device, etc.), or any other device capable of processing information as described in more detail below.

The server_1 106 through the server_N 108 provide web content that may be accessed by the DOM application development device 102. As such, the server_1 106 through the server_N 108 represent web servers and other content servers for purposes of the present description.

The network 104 may include any form of interconnection suitable for the intended purpose, including a private or public network such as an intranet or the Internet, respectively, direct inter-module interconnection, dial-up, wireless, or any other interconnection mechanism capable of interconnecting the devices within the system 100.

FIG. 2 is a block diagram of an example of an implementation of the DOM application development device 102 that provides the DOM application framework. A central processing unit (CPU) 200 provides computer instruction execution, computation, and other capabilities within the DOM application development device 102. A display 202 provides visual information to a user of the DOM application development device 102 and an input device 204 provides input capabilities for the user.

The display 202 may include any display device, such as a cathode ray tube (CRT), liquid crystal display (LCD), light emitting diode (LED), projection, touchscreen, or other display element or panel. The input device 204 may include a computer keyboard, a keypad, a mouse, a pen, a joystick, or any other type of input device by which the user may interact with and respond to information on the display 202.

A communication module 206 provides interconnection capabilities that allow the DOM application development device 102 to communicate with other modules within the system 100, such as the server_1 106 through the server_N 108, to retrieve web content. The communication module 206 may include any electrical, protocol, and protocol conversion capabilities useable to provide the interconnection capabilities. Though the communication module 206 is illustrated as a component-level module for ease of illustration and description purposes, it should be noted that the communication module 206 may include any hardware, programmed processor(s), and memory used to carry out the functions of the communication module 206 as described above and in more detail below. For example, the communication module 206 may include additional controller circuitry in the form of application specific integrated circuits (ASICs), processors, antennas, and/or discrete integrated circuits and components for performing communication and electrical control activities associated with the communication module 206. Additionally, the communication module 206 may include interrupt-level, stack-level, and application-level modules as appropriate. Furthermore, the communication module 206 may include any memory components used for storage, execution, and data processing for performing processing activities associated with the communication module 206. The communication module 206 may also form a portion of other circuitry described without departure from the scope of the present subject matter.

A memory 208 includes a DOM development information storage area 210 that stores information associated with instantiable DOM components that are either created or captured by the DOM application development device 102. The information stored within the DOM development information storage area 210 may include information such as interface attributes (e.g., input and output attributes), and other related information for DOM components, and may also include application-level attributes for instantiated DOM components integrated into a DOM application. The memory 208 also includes a DOM instantiation storage area 212 that stores, for example, reusable DOM components that have been instantiated into useable DOM objects with related application-level functionality and integrated DOM applications. Other information associated with the DOM application framework may be stored within either the DOM development information storage area 210 or the DOM instantiation storage area 212, as appropriate for a given implementation.

It is understood that the memory 208 may include any combination of volatile and non-volatile memory suitable for the intended purpose, distributed or localized as appropriate, and may include other memory segments not illustrated within the present example for ease of illustration purposes. For example, the memory 208 may include a code storage area, a code execution area, and a data area without departure from the scope of the present subject matter.

The DOM application development device 102 also includes a DOM development module 214. The DOM development module 214 implements the DOM application framework within the DOM application development device 102 and provides functionality for creation of instantiable DOM components, capture of DOM components from remote servers, such as the server_1 106 through the server_N 108, and storage of DOM components for reuse. The DOM development module 214 also provides functionality for instantiation and integration of stored DOM components. In addition, the DOM development module 214 provides other functions associated with the DOM application framework within the DOM application development device 102, as described above and in more detail below.

Though the DOM development module 214 is illustrated as a component-level module for ease of illustration and description purposes, it should be noted that the DOM development module 214 may include any hardware, programmed processor(s), and memory used to carry out the functions of the DOM development module 214 as described above and in more detail below. For example, the DOM development module 214 may include additional controller circuitry in the form of application specific integrated circuits (ASICs), processors, and/or discrete integrated circuits and components for performing communication and electrical control activities associated with the DOM development module 214. Additionally, the DOM development module 214 may include interrupt-level, stack-level, and application-level modules as appropriate. Furthermore, the DOM development module 214 may include any memory components used for storage, execution, and data processing for performing processing activities associated with the DOM development module 214.

It should also be noted that the DOM development module 214 may form a portion of other circuitry described without departure from the scope of the present subject matter. Further, the DOM development module 214 may alternatively be implemented as an application stored within the memory 208. In such an implementation, the DOM development module 214 may include instructions executed by the CPU 200 for performing the functionality described herein. The CPU 200 may execute these instructions to provide the processing capabilities described above and in more detail below for the DOM application development device 102. The DOM development module 214 may form a portion of an interrupt service routine (ISR), a portion of an operating system, a portion of a browser application, or a portion of a separate application without departure from the scope of the present subject matter.

A database 216 is associated with the DOM application development device 102 and provides storage capabilities for information associated with the DOM application framework implemented by the DOM application development device 102. The database 216 includes a DOM components storage area 218 that may be stored in the form of tables or other arrangements accessible by the DOM application development device 102. The DOM components storage area 218 includes captured instantiable DOM components associated with accessed web or other servers, such as the server_1 106 through the server_N 108, and instantiable DOM components created by the DOM development module 214. The DOM components storage area 218 also includes additional information associated with instantiable DOM components, such as executable code and metadata defining inputs and outputs for instantiable executable DOM components, as well as other information useable in association with instantiation of stored DOM components.

It should also be noted that web content associated with web content servers, such as the server_1 106 through the server_N 108, may be accessed and executed as stored on the respective servers using techniques, such as asynchronous Javascript and XML (AJAX). Accordingly, there is no requirement to locally store DOM objects that are accessible via such a server.

The CPU 200, the display 202, the input device 204, the communication module 206, the memory 208, the DOM development module 214, and the database 216 are interconnected via an interconnection 220. The interconnection 220 may include a system bus, a network, or any other interconnection capable of providing the respective components with suitable interconnection for the respective purpose.

While the DOM application development device 102 is illustrated with and has certain components described, other modules and components may be associated with the DOM application development device 102 without departure from the scope of the present subject matter. Additionally, it should be noted that, while the DOM application development device 102 is described as a single device for ease of illustration purposes, the components within the DOM application development device 102 may be co-located or distributed and interconnected via a network without departure from the scope of the present subject matter. For a distributed arrangement, the display 202 and the input device 204 may be located at a point of sale device, kiosk, or other location, while the CPU 200 and memory 208 may be located at a local or remote server. Many other possible arrangements for components of the DOM application development device 102 are possible and all are considered within the scope of the present subject matter. It should also be understood that, though the DOM components storage area 218 is shown within the database 216, it may also be stored within the memory 208 without departure from the scope of the present subject matter. Accordingly, the DOM application development device 102 may take many forms and may be associated with many platforms.

Regarding format for creation, capture, storage, and retrieval of DOM components, any suitable format may used. For example, a markup language (ML), such as hypertext markup language (HTML), may be used. Additional example markup languages include extensible markup language (XML) and standard generalized markup language (SGML). Many other markup languages exist and all are considered within the scope of the present subject matter. Elements found within an ML document may be accessed, changed, deleted, and/or added using the DOM representation for the respective elements. An ML representation of web content may be split into tokens and placed within a DOM tree. These instantiated DOM objects may be captured, stored, and retrieved to form reusable DOM components. Storage of instantiable DOM components may be in any suitable format, including ML format. Accordingly, the associated DOM components may take many forms and may be associated with many formats.

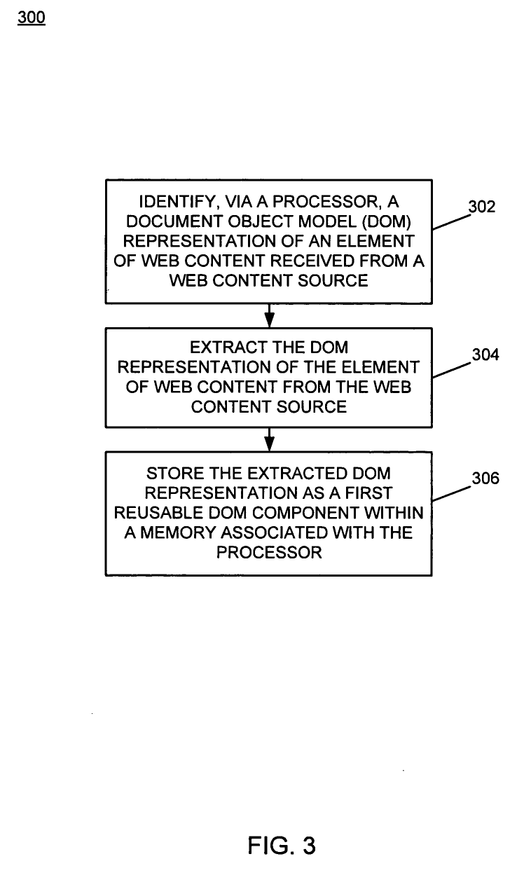

FIG. 3 through FIG. 5B below describe example processes that may be executed by devices, such as the DOM application development device 102, to provide the DOM application framework associated with the present subject matter. Many other variations on the example processes are possible and all are considered within the scope of the present subject matter. The example processes may be performed by modules, such as the DOM development module 214 and/or executed by the CPU 200, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 for providing a DOM application framework. At block 302, the process 300 identifies, via a processor, a document object model (DOM) representation of an element of web content received from a web content source. At block 304, the process 300 extracts the DOM representation of the element of web content from the web content source. At block 306, the process 300 stores the extracted DOM representation as a first reusable DOM component within a memory associated with the processor.

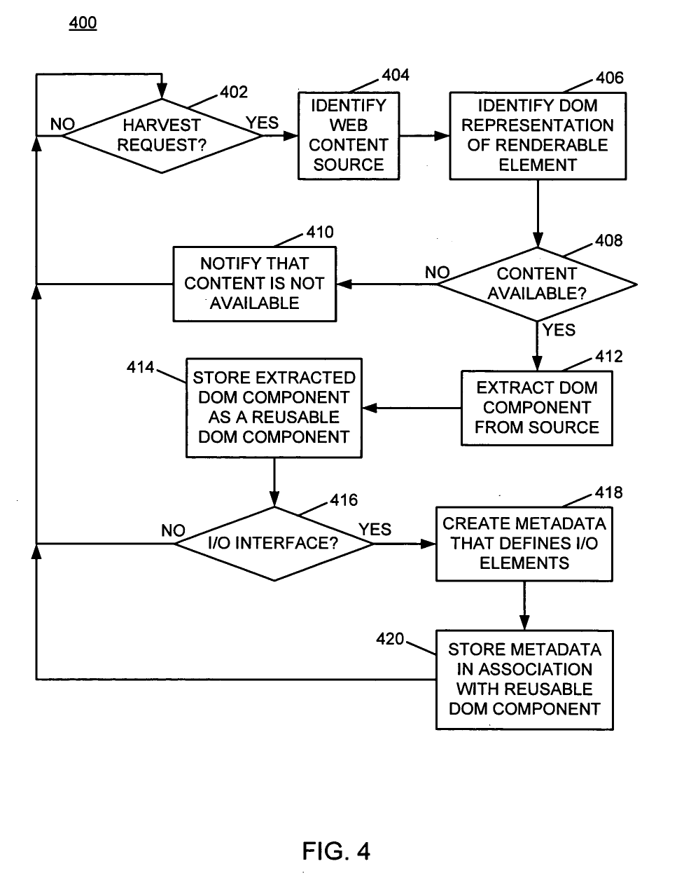

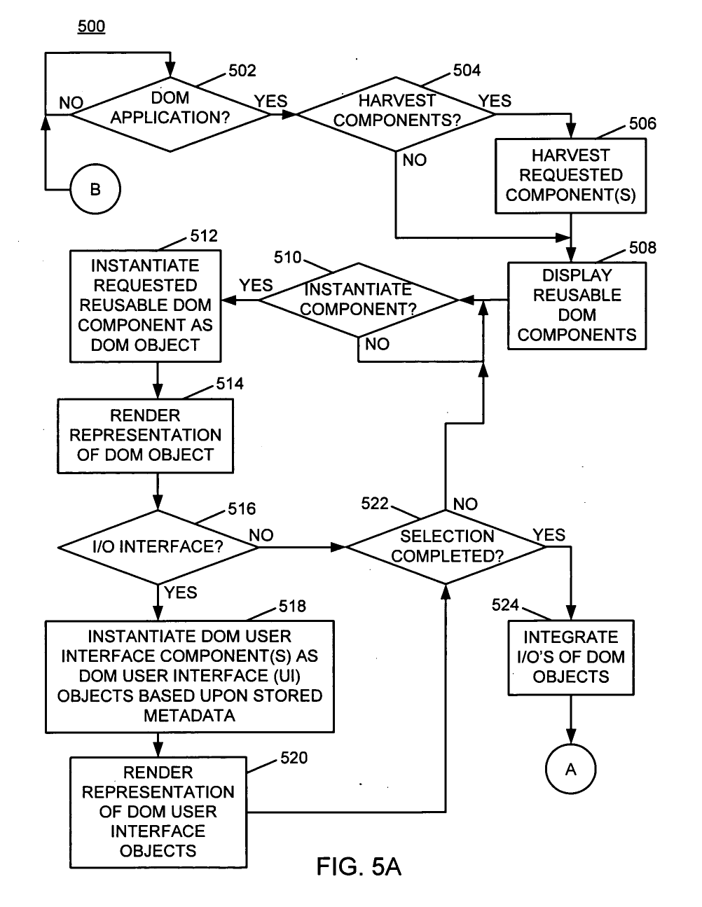

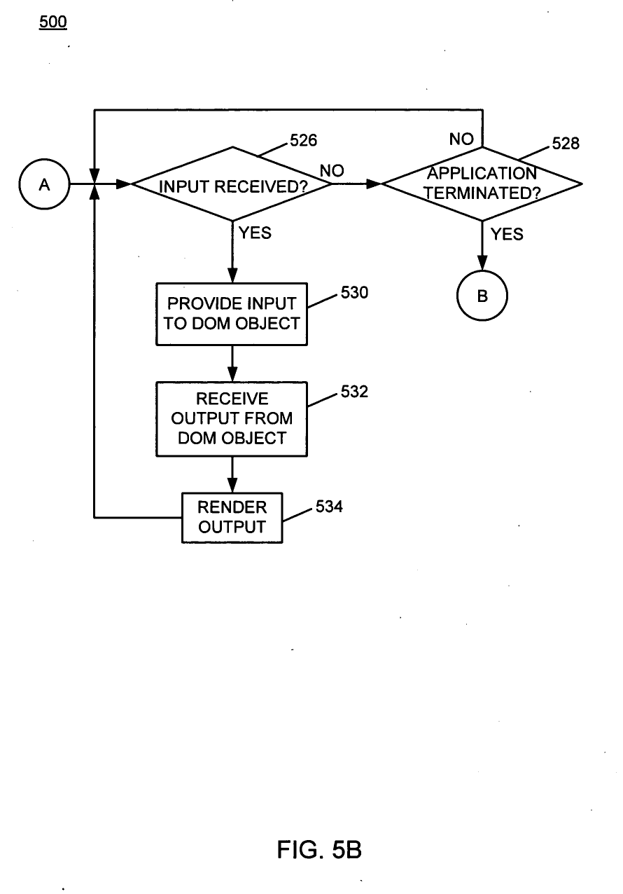

FIG. 4 is a flow chart of an example of an implementation of a process 400 for DOM component harvesting from a server, such as one of the server_1 106 through the server_N 108. At decision point 402, the process 400 waits to receive a request to harvest a DOM component. For purposes of the present subject matter, a request to harvest a DOM component may be received, for example, from a user via interaction with a device, such as the input device 204. The request may be received in response to the user making a selection via the input device 204, such as a pop-up menu selection, to harvest a DOM component associated with an item of rendered web content. As such, the DOM component may include a renderable element of web content that is rendered via a display, such as the display 202. It should also be noted that the request to harvest a DOM component may also be received in association with processing described below in FIG. 5A.

When a determination is made at decision point 402 that a request to harvest a DOM component has been received, the process 400 identifies a web content source associated with the DOM component at block 404. The web content source may include a server, such as one of the server_1 106 through the server_N 108. At block 406, the process 400 identifies a DOM representation of the renderable element of web content. Identification of the DOM representation of the renderable element of web content may include identification of a DOM representation of the web content and identification of a DOM representation of the renderable element of web content within the identified DOM representation.

At decision point 408, the process 400 makes a determination as to whether the requested DOM component is available and accessible via the web content source. The determination as to whether the requested DOM component is available and accessible via the web content source may also include making a determination as to whether associated executable code is available and accessible via the web content source.

When a determination is made at decision point 408 that the requested DOM component and any associated executable code is not available and accessible via the web content source, the process 400 notifies the user, such as via a message displayed on the display 202, that the requested content is not available at block 410. The process 400 then returns to decision point 402 to await another request to harvest a DOM component. When a determination is at decision point 408 that the requested DOM component and any associated executable code is available and accessible via the web content source, the process 400 extracts the requested DOM component from the web content source, including any associated executable code at block 412. At block 414, the process 400 stores the extracted DOM component as a reusable DOM component, such as within the DOM components storage area 218 of the database 216.

At decision point 416, the process 400 makes a determination as to whether any input/output (I/O) data interface attributes are associated with the extracted and stored reusable DOM component. When a determination is made that at least one I/O data interface attribute is associated with the extracted and stored reusable DOM component, the process 400 creates metadata that defines an input data element associated with any determined input data interface attribute and an output data element associated with any determined output data interface attribute for the reusable DOM component at block 418. At block 420, the process 400 stores the metadata in association with the reusable DOM component in a memory, such as in the DOM components storage area 218 of the database 216 or the memory 208.

Upon completion of storing the metadata in association with the reusable DOM component in a memory at block 420 or upon making a determination at decision point 416 that there are no I/O interface attributes is associated with the extracted and stored reusable DOM component, the process 400 returns to decision point 402 to await a new request to harvest a DOM component.

As such, the process 400 provides DOM component harvesting by identifying a web content source for a renderable element of web content. The process 400 identifies a DOM representation associated with the renderable element of web content, extracts the DOM component from the web content source, and stores the extracted DOM component as a reusable DOM component along with metadata that identifies any I/O interface attributes for the reusable DOM component.

FIG. 5A and FIG. 5B illustrate a flow chart of an example of an implementation of a process 500 that provides a DOM application framework and that provides a user of a device, such as the DOM application development device 102, with functionality to build and execute DOM applications. FIG. 5A illustrates initial processing within the process 500. At decision point 502, the process 500 waits to receive a request to build a DOM application. For purposes of the present subject matter, a request to build a DOM application may be received, for example, from a user via interaction with a device, such as the input device 204. The request may be received in response to the user making a selection via the input device 204, such as a pop-up menu selection, to build a DOM application.

When a determination is made at decision point 502 that a request to build a DOM application has been received, the process 500 makes a determination at decision point 504 as to whether to harvest at least one DOM component for use in building the DOM application. The determination as to whether to harvest at least one DOM component may be based upon additional information associated with the received request to build the DOM application. When a determination is made at decision point 504 to harvest at least one DOM component, the process 500 harvests the requested DOM component at block 506. It should be noted that processing such as that described above in association with FIG. 4 may be used to harvest any requested DOM component(s).

Upon completion of any requested DOM component harvesting at block 506 or upon making a determination at decision point 504 not to harvest any DOM components, the process 500 displays any available reusable DOM components at block 508. Displaying available DOM components may include displaying a representation of the reusable DOM component on a display, such as the display 202, associated with the DOM development module 214. Displaying the representation of the reusable DOM component may further include displaying an iconic representation of the reusable DOM component on the display 202. Displaying the iconic representation of the reusable DOM component on the display 202 may further include displaying an indication of any input data attribute(s)/element(s) and any output data attribute(s)/element(s) associated with the reusable DOM component in association with the iconic representation of the reusable DOM component on the display 202.

At decision point 510, the process 500 makes a determination as to whether to instantiate a reusable DOM component. The determination as to whether to instantiate a reusable DOM component may be based upon receipt of a request via the input device 202 in response to user interaction with and selection of a displayed DOM component and selection of a menu item to request instantiation of the selected DOM component. For purposes of the present example, it is assumed that the user selects at least one DOM component to be instantiated.

When a determination is made at decision point 510 that a request to instantiate a reusable DOM component has been received, the process 500 instantiates the requested reusable DOM component as a DOM object, such as within the DOM instantiation storage area 212 of the memory 208, in response to the instantiation request at block 512. At block 514, the process 500 renders a representation of the DOM object, such as on the display 202. Rendering the representation of the DOM object may include displaying a representation of the DOM object on the display 202 as an iconic representation of the DOM object, including instantiated input/output interface elements.

It should be noted that instantiated DOM objects may be distinguished from reusable DOM components via any approach suitable for a given implementation. For example, different panels within a graphical user interface (GUI) may be maintained for reusable DOM components and instantiated DOM objects. Many other possibilities exist for displaying and distinguishing reusable DOM components and instantiated DOM objects and all are considered within the scope of the present subject matter.

Displaying the iconic representation of the instantiated DOM object on the display 202 may further include displaying an indication of any instantiated I/O element(s) associated with the instantiated DOM object in association with the iconic representation of the instantiated DOM object on the display 202. I/O elements may be instantiated, as described above, based upon stored metadata defining I/O attributes associated with reusable DOM components. Displaying the indication of any instantiated I/O element(s) may be performed in any manner suitable for a given implementation. For example, the indication of any instantiated I/O element(s) may be presented via a graphical representation of an I/O element graphically coupled to the iconic representation of the instantiated DOM object via a leader line or any other suitable indication.

At decision point 516, the process 500 makes a determination as to whether any DOM user interface components are associated with the instantiated DOM object. When a determination is made that at least one I/O data interface attribute is associated with the instantiated DOM object, the process 500 instantiates any DOM user interface component as a DOM user interface object based upon the stored metadata within the memory, such as the memory 208, at block 518. Instantiating any DOM user interface object(s) may be performed based upon metadata that defines I/O attributes for the instantiated DOM object.

At block 520, the process 500 renders the instantiated DOM user interface object(s). Rendering the instantiated DOM user interface object(s) may be performed in any manner suitable for a given implementation. For example, the instantiated DOM user interface object(s) may be presented via a graphical representation that is graphically coupled to the iconic representation of the instantiated DOM object via a leader line or any other suitable indication.

Upon completion of instantiation of any DOM user interface objects for the instantiated DOM object at block 520 or upon determining at decision point 516 that there are no DOM user interface components associated with the instantiated DOM object, the process 500 makes a determination at decision point 522 as to whether DOM component selection has been completed. The determination as to whether DOM component selection has been completed may be made in response to a user interaction with the input device 204 indicating that DOM component selection for the application is completed. The determination at decision point 522 may also be made in response to receipt of a request to integrate the instantiated DOM object with at least one other reusable DOM component.

When a determination is made at decision point 522 that DOM component selection has not been completed (e.g., that a request has been received to integrate the instantiated DOM object with at least one other reusable DOM component), the process 500 returns to decision point 510 to instantiate another reusable DOM component and iterates as described above. When a determination is made at decision point 522 that DOM component selection has been completed, the process 500 integrates the instantiated DOM object(s) with the at least one other instantiated DOM object in response to the integration request at block 524. As such, a DOM application has been built and configured for execution based upon user selections of reusable DOM components, instantiation of the selected reusable DOM components, and integration of instantiated DOM objects. The process 500 transitions to the processing shown and described in association with FIG. 5B.

FIG. 5B illustrates additional processing associated with the process 500 for executing the DOM application that has been built. At decision point 526, the process 500 makes a determination as to whether any input has been received for the DOM application. When a determination is made that no input has been received, the process 500 makes a determination at decision point 528 as to whether a request to terminate the DOM application has been received from the user via the input device 204. When a determination is made at decision point 528 that a request to terminate the DOM application has not been received from the user via the input device 204, the process 500 returns to decision point 526 and iterates as described above.

When a determination is made at decision point 526 that input has been received for the DOM application, the process 500 receives user input associated with the DOM application. For example, input may be received in association with any rendered representation of an instantiated reusable DOM user interface component via the input device 204 associated with the DOM development module 214.

At block 530, the process 500 provides the user input to the instantiated DOM object. At block 532, the process 500 receives an output from the instantiated DOM object. At block 534, the process 500 renders the output from the instantiated DOM object on the display 202 for the user to review. It should be noted that the process 500 may also write the output to a memory location or to an output device, such as a printer (not shown) without departure from the scope of the present subject matter.

Upon completion of rendering the output from the instantiated DOM object on the display 202 for the user to review, the process 500 returns to decision point 526 and iterates as described above. When a determination is made at decision point 528 that a request to terminate the DOM application has been received from the user via the input device 204, the process 500 returns to decision point 502, as described above and illustrated in association with FIG. 5A to await a new request to build a DOM application.

As such, the process 500 provides for harvesting and displaying of reusable DOM components, instantiation of selected DOM components, and instantiation of user interface objects for selected reusable DOM components based upon stored metadata that defines I/O attributes for reusable DOM components. The process 500 also provides for execution of a DOM application built in response to user selection and instantiation of selected DOM components.

As described above in association with FIG. 1 through FIG. 5B, the example systems and processes provide a document object model (DOM) application framework. Many other variations and additional activities associated with the DOM application framework are possible and all are considered within the scope of the present subject matter.

Those skilled in the art will recognize, upon consideration of the above teachings, that certain of the above examples are based upon use of a programmed processor, such as the CPU 200. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
identifying, via a processor, a document object model (DOM) representation of an element of web content received from a web content source;
extracting the DOM representation of the element of web content from the web content source; and
storing the extracted DOM representation as a first reusable DOM component within a memory associated with the processor.

2. The method of claim 1, further comprising:
determining that at least one of an input data interface attribute and an output data interface attribute is associated with the first reusable DOM component;
creating metadata that defines the at least one of the input data attribute and the output data attribute for the first reusable DOM component; and
storing the metadata in association with the first reusable DOM component in the memory.

3. The method of claim 2, further comprising:
displaying a representation of the first reusable DOM component on a display associated with the processor;
receiving a request to instantiate the first reusable DOM component;
instantiating the first reusable DOM component as a first DOM object within the memory in response to the instantiation request; and
rendering a representation of the first DOM object on the display.

4. The method of claim 3, where instantiating the first reusable DOM component as the first DOM object within the memory in response to the instantiation request comprises:
instantiating a first DOM user interface object in association with the first DOM object based upon the stored metadata;
receiving a request to integrate the first DOM object with a second reusable DOM component;
instantiating the second reusable DOM component as a second DOM object within the memory in response to the integration request;
instantiating a second DOM user interface object in association with the second DOM object in response to the integration request; and
integrating the first DOM object with the second DOM object via the first DOM user interface object associated with the first DOM object and the second DOM user interface object associated with the second DOM object.

5. The method of claim 3, where displaying the representation of the first reusable DOM component on the display associated with the processor comprises:
displaying an iconic representation of the first reusable DOM component on the display in association with an iconic representation of a second reusable DOM component; and
displaying an indication of at least one of an input data attribute and an output data attribute associated with at least one of the iconic representation of the first reusable DOM component and the iconic representation of the second reusable DOM component on the display.

6. The method of claim 3, further comprising:
instantiating at least one of an input data attribute and an output data attribute associated with the first DOM object as at least one DOM user interface object based upon the stored metadata;
rendering a representation of the at least one DOM user interface object with the first DOM object on the display;
receiving user input associated with the rendered representation of the at least one DOM user interface object via a user input device associated with the processor;
providing the user input to the first DOM object;
receiving an output from the first DOM object; and
rendering the output from the first DOM object on the display.

7. The method of claim 1, where:
extracting the DOM representation of the element of web content from the web content source comprises extracting at least one of source web content and executable code associated with the element of web content from the web content source; and
storing the extracted DOM representation as the first reusable DOM component within the memory associated with the processor comprises storing the at least one of the extracted source web content and the extracted executable code in association with the first reusable DOM component.

8. A system, comprising:
a memory; and
a processor programmed to:
identify a document object model (DOM) representation of an element of web content received from a web content source;
extract the DOM representation of the element of web content from the web content source; and
store the extracted DOM representation as a first reusable DOM component within the memory.

9. The system of claim 8, where the processor is further programmed to:
determine that at least one of an input data interface attribute and an output data interface attribute is associated with the first reusable DOM component;
create metadata that defines the at least one of the input data attribute and the output data attribute for the first reusable DOM component; and
store the metadata in association with the first reusable DOM component in the memory.

10. The system of claim 9, further comprising:
a display; and
where the processor is further programmed to:
display a representation of the first reusable DOM component on the display;
receive a request to instantiate the first reusable DOM component;
instantiate the first reusable DOM component as a first DOM object within the memory in response to the instantiation request; and
render a representation of the first DOM object on the display.

11. The system of claim 10, where, in being programmed to instantiate the first reusable DOM component as the first DOM object within the memory in response to the instantiation request, the processor is programmed to:
instantiate a first DOM user interface object in association with the first DOM object based upon the stored metadata;
receive a request to integrate the first DOM object with a second reusable DOM component;
instantiate the second reusable DOM component as a second DOM object within the memory in response to the integration request;
instantiate a second DOM user interface object in association with the second DOM object in response to the integration request; and
integrate the first DOM object with the second DOM object via the first DOM user interface object associated with the first DOM object and the second DOM user interface object associated with the second DOM object.

12. The system of claim 10, where, in being programmed to display the representation of the first reusable DOM component on the display, the processor is programmed to:
display an iconic representation of the first reusable DOM component on the display in association with an iconic representation of a second reusable DOM component; and
display an indication of at least one of an input data attribute and an output data attribute associated with at least one of the iconic representation of the first reusable DOM component and the iconic representation of the second reusable DOM component on the display.

13. The system of claim 10, further comprising:
a user input device; and
where the processor is programmed to:
instantiate at least one of an input data attribute and an output data attribute associated with the first DOM object as at least one DOM user interface object based upon the stored metadata;
render a representation of the at least one DOM user interface object with the first DOM object on the display;
receive user input associated with the rendered representation of the at least one DOM user interface object via the user input device;
provide the user input to the first DOM object;
receive an output from the first DOM object; and
render the output from the first DOM object on the display.

14. A computer program product comprising a computer readable storage medium including a computer readable program, wherein the computer readable program when executed on a computer causes the computer to:
identify a document object model (DOM) representation of an element of web content received from a web content source;
extract the DOM representation of the element of web content from the web content source; and
store the extracted DOM representation as a first reusable DOM component within a memory.

15. The computer program product of claim 14, wherein the computer readable program when executed on the computer further causes the computer to:
determine that at least one of an input data interface attribute and an output data interface attribute is associated with the first reusable DOM component;
create metadata that defines the at least one of the input data attribute and the output data attribute for the first reusable DOM component; and
store the metadata in association with the first reusable DOM component in the memory.

16. The computer program product of claim 15, wherein the computer readable program when executed on the computer further causes the computer to:
display a representation of the first reusable DOM component on a display;
receive a request to instantiate the first reusable DOM component;
instantiate the first reusable DOM component as a first DOM object within the memory in response to the instantiation request; and
render a representation of the first DOM object on the display.

17. The computer program product of claim 16, where, in causing the computer to instantiate the first reusable DOM component as the first DOM object within the memory in response to the instantiation request, the computer readable program when executed on the computer causes the computer to:
instantiate a first DOM user interface object in association with the first DOM object based upon the stored metadata;
receive a request to integrate the first DOM object with a second reusable DOM component;
instantiate the second reusable DOM component as a second DOM object within the memory in response to the integration request;
instantiate a second DOM user interface object in association with the second DOM object in response to the integration request; and
integrate the first DOM object with the second DOM object via the first DOM user interface object associated with the first DOM object and the second DOM user interface object associated with the second DOM object.

18. The computer program product of claim 16, where, in causing the computer to display the representation of the first reusable DOM component on the display, the computer readable program when executed on the computer causes the computer to:
display an iconic representation of the first reusable DOM component on the display in association with an iconic representation of a second reusable DOM component; and
display an indication of at least one of an input data attribute and an output data attribute associated with at least one of the iconic representation of the first reusable DOM component and the iconic representation of the second reusable DOM component on the display.

19. The computer program product of claim 16, wherein the computer readable program when executed on the computer further causes the computer to:
instantiate at least one of an input data attribute and an output data attribute associated with the first DOM object as at least one DOM user interface object based upon the stored metadata;
render a representation of the at least one DOM user interface object with the first DOM object on the display;
receive user input associated with the rendered representation of the at least one DOM user interface object via a user input device;
provide the user input to the first DOM object;
receive an output from the first DOM object; and
render the output from the first DOM object on the display.

20. The computer program product of claim 1, where:
in causing the computer to extract the DOM representation of the element of web content from the web content source, the computer readable program when executed on the computer causes the computer to extract at least one of source web content and executable code associated with the element of web content from the web content source; and
in causing the computer to store the extracted DOM representation as the first reusable DOM component within the memory, the computer readable program when executed on the computer causes the computer to store the at least one of the extracted source web content and the extracted executable code in association with the first reusable DOM component.
